(19) United States
(12) Patent Application Publication
(10) Pub. No.: US 2014/0145388 A1
(43) Pub. Date: May 29, 2014

(54) HOLDING DEVICE FOR AT LEAST ONE-RIM LIKE BODY

(71) Applicant: Waldemar STRUGAR, Bottrop (DE)

(72) Inventor: Waldemar STRUGAR, Bottrop (DE)

(21) Appl. No.: 14/091,411

(22) Filed: Nov. 27, 2013

(30) Foreign Application Priority Data
Nov. 27, 2012 (DE) 20 2012 104 604.0

(51) Int. Cl. B05B 13/02

(52) U.S. Cl. CPC B05B 13/0228; B05B 13/0285
USPC 269/79; 269/55

(57) ABSTRACT

The present invention relates to a holding device for at least one rim-like body for the surface treatment of the at least one rim-like body, in particular for painting it by means of a spraying device or a spraying tool, the holding device comprising a stand frame, at least one bearing element which is mounted on the stand frame such that it can be rotated or pivoted around a rotation axis, and at least one holding element which is mounted on the bearing element such that it can be rotated or pivoted around a rotation axis and to which the at least one rim-like body can be fastened.

### CROSS REFERENCE TO RELATED APPLICATIONS

This application claims priority to German Patent Application No. 20 2012 104 604.0 filed on Nov. 27, 2012, the disclosure of which is incorporated by reference herein in its entirety.

### FIELD OF THE INVENTION

The present invention relates to a holding device for at least one rim-like body for a surface treatment of the at least one rim-like body, in particular for painting the body by means of a spraying device or a spraying tool.

### BACKGROUND

From the state of the art devices are known which comprise a stand frame and at least one receiver for at least one rim. The receiver is cone-shaped such that a rim can be placed from above on this conical receiver. It is a disadvantage of such conical receivers that no secure hold of the rim can be assured. In particular with respect to rims having a great diameter, this can lead to stability problems and it might happen that the rim falls down. Herein, the rim can be badly damaged such that this one will be perhaps no more usable.

The conical receivers known from the state of the art can furthermore only be displaced in the horizontal direction. A slight rotation of the rim along a rotation axis is not possible since the rim cannot be fixed. Due to the lacking possibility to fix the rim to the holding device it is highly difficult to assure a regular color application. This is in particular disadvantageous at points which are difficult to access, such as for example the inner edge of the rim next to the tire, since it might happen that air leaks from a tire if the painting is irregular.

Furthermore, a rim can only be painted on respectively one side. For painting the rim entirely it is thus required to paint for instance the inner side of the rim in a first working step and then to paint for example the outer side of the rim in a second working step. Herein it is disadvantageous that the rim has to be turned over between the different working steps and the working operation has to be interrupted. Besides, traces caused by the turning can be left on the applied painting at the contact points which traces have to be reworked in an additional working step.

Thus it is another disadvantage from an ergonomic point of view that a rim cannot be painted in one working operation. This makes the painting time consuming since it is not possible to paint continuously and reworks have to be carried out. Hereby the costs of painting a rim rise.

In view of this state of the art, it is the object of the invention to provide an improved device for treating the surface of a rim, in particular for painting it, which device enables to treat the rim in one continuous working operation. Furthermore, a device shall be created which assures a secure hold of a rim such that material damages of the rim, for instance caused by falling down, can be excluded. Another object of the invention is to organize the painting operation of a rim in an as time efficient and ergonomic manner as possible and thus to reduce the costs of a rim painting, in particular by reducing the required reworks.

### SUMMARY

For the technical solution of this problem the invention proposes a holding device for at least one rim-like body for the surface treatment of the at least one rim-like body, in particular for painting it by means of a spraying device, the holding device comprising a stand frame, at least one bearing element which is mounted on the stand frame such that it can be rotated or pivoted around a rotation axis, and at least one holding element which is mounted on the bearing element such that it can be rotated or pivoted around a rotation axis and to which the at least one rim-like body can be fastened.

Herein, the invention is based upon the knowledge that is shall be possible to treat a rim-like body, especially a wheel rim, from all sides without having to newly position the rim-like body on the holding device and to interrupt the working operation. Furthermore it shall be possible to carry out a treatment in an ergonomically optimum manner with respect to the painting process.

Hereby, so called paint runs and/or over-spraying during the application of the paint as well as color mists and dust inclusions related thereto can be avoided to a large extend. This reduces the required material as well as the work time required for painting the rim-like body. The ergonomics of the painting operation is furthermore improved. This is of special importance when special paint works, for instance multicolor painting or painting with decorative strips are concerned, since the rim-like body can be for example masked (for example by masking tape) and painted with different colors and/or materials in a continuous working operation by means of the holding device according to the invention. Preparatory and subsequent works required for the painting, such as filling, grinding and polishing of the rim, can also be carried out during the same working operation without any interruption and without a new positioning of the rim which is known from the state of the art.

Another finding of the invention is that thanks to a biaxial and balanced design of the device a secure treatment and processing of especially big rims can also be realized. Furthermore, an improved ventilation of the rim-like body in comparison to common devices is obtained. The possibility to set the rim-like body into rotation can for instance reduce the drying/curing time. Furthermore, so called runs which can occur during painting, can be rectified by the painter by means of a targeted rotation.

One embodiment of the invention is characterized in that the direction of the rotation axis of the bearing element is different from the direction of the rotation axis of the holding element. A preferred embodiment of the invention provides that the rotation axis of the bearing element is orthogonal to the rotation axis of the holding element. The invention profits from the advantageous fact that a rim-like body can be accessed by a painter from all sides if two rotation axes that are in particular orthogonal with respect to each other are used. The result is that a rim can be painted in a highly ergonomic manner since a painter who carries out the work does not have to change his position. The targeted orientation of the two rotation axes with respect to each other can furthermore lead to a balanced holding of the rim-like body by means of the device. This allows a stable treatment of in particular large rims. Besides, the repositioning of the rim for treating it from all sides can be omitted. Thus, no contact points are created at which traces can be left and which have to be reworked for a successful result.

Another embodiment of the invention provides that the at least one bearing element can be locked on the stand frame. This enables a fixation of the rim-like body that is fastened to the at least one bearing element at a position within the rotation axis of the bearing element. This may be required for particular working operations. In another advantageous embodiment, the locking mechanism can be actuated by an external mechanism, for instance by an actuating element for locking that will be actuated by the painter's foot, which actuating element is preferably located in the area of the ground. For this purpose, a gearwheel can be mounted on the rotation axis of the at least one bearing element, which gearwheel can snap into a lock. The lock can be released by the actuating element that is placed on the ground, such that the locking mechanism of the at least one bearing element can be released and consequently a locking option is obtained. In particular the ergonomics of the treatment of the surface of the rim-like body will be improved hereby.

An especially preferred embodiment of the invention is characterized in that the at least one bearing element is essentially U-shaped, wherein the U-shape comprises two free legs and a connecting leg. This design of the bearing element enables to fix a rim-like body to be treated nearly in its center of gravity on the holding device. Hereby, the rotation of the rim-like body fastened to the holding device is especially facilitated because a painter only needs to apply a minimum force. The pivot bearing which assures a rotatability or pivotability of the bearing element on the stand frame is placed on a free leg of the U-shaped bearing element and the pivot bearing of the holding element is placed on the other free leg.

One embodiment of the invention provides that the lengths of the legs of the at least one essentially U-shaped bearing element are adapted to the size of the at least one rim-like body. Herein, the free legs are preferably adapted to the inst of a rim-like body to be treated and the connecting leg is adapted to the radius or diameter of the rim-like body. It can thus be assured that especially large rim-like bodies can also be fastened to the holding device.

Another embodiment of the invention provides that the free legs of the at least one essentially U-shaped bearing element comprise a length of approximately 20 cm to approximately 80 cm, preferably approximately 35 cm to approximately 65 cm, most preferably approximately 45 cm to approximately 55 cm. This assures that rims which are available on the market and commonly used can be treated in the holding device according to the invention, in particular rims having different insets.

One embodiment according to the invention provides that the connecting leg of the at least one essentially U-shaped bearing element comprises a length of approximately 20 cm to approximately 70 cm, preferably approximately 30 cm to approximately 60 cm, most preferably approximately 40 cm to approximately 50 cm. It is thus possible to treat all rims that are available on the market and commonly used by means of the device according to the invention, in particular rims having diameters of up to approximately 26 inches. These ones can be fastened to the holding device thanks to the dimensions of the essentially U-shaped bearing element. The dimensions of the holding device can be further adapted for rendering the treatment of still larger rims, for instance truck rims, possible.

One embodiment of the invention is characterized in that the at least one holding element can be locked on the at least one bearing element. Hereby, a rim-like body can be fixed in every position within the rotation axis of the holding element. This can be in particular useful for individual paintings, since a painter can concentrate on a special portion of the rim-like body and treat this one correspondingly without having to newly position himself.

A preferred embodiment of the invention provides that the at least one holding element is designed like a flange and the at least one rim-like body can be fastened by means of at least one fastening means, preferably to the free leg of the essentially U-shaped bearing element on which the at least one flange-like holding element is mounted in a rotatable or pivotable manner. In contrast to the solutions known from the state of the art, in which a fixation of a rim-like body to be treated is not provided, a stable hold of a rim-like body on the holding device according to the invention can be assured hereby. Herein, the flange can be preferably round and comprise several, preferably four or five bores for fastening means at different positions. This enables to firmly connect rims having different bolt circles, for example with three, four or five bores in the bolt circle, to the flange by means of a fastening means. The fastening means is preferably a wheel bolt. During the treatment of a rim-like body it might be sufficient to fix the rim-like body to the holding element of the holding device by means of a minimum number of fastening means in order to assure a secure hold of the rim-like body. Another advantageous embodiment of the invention provides a cone bolt with hexagon socket, a so called hex, or the like as fastening means for fastening the rim to the holding element, especially because this cone bolt enables a simpler and quicker fastening due to the conical screw head, which fastening is supported by the use of a hexagon socket or the like.

Another embodiment provides that the diameter of the flange-like holding element is comprised between approximately 5 cm and approximately 20 cm, preferably between approximately 7 cm and approximately 17 cm, most preferably between approximately 11 cm and approximately 14 cm. Hereby it is assured that no material is applied to the contact surface which is formed between a wheel hub on a car and the rim-like body. This has to be in particular avoided because the application of color can lead to unevenness at this point and consequently a rim cannot be sufficiently fixed to the wheel suspension of a car. The strong rotation of the rim caused by the driving motion of the car can lead to an unbalance or the rim can come loose. A sufficiently great diameter of the flange assures that no color can be applied to this point and thus the described disadvantages are avoided thanks to the construction of the holding device according to the invention.

Another preferred embodiment of the invention is characterized in that the stand frame is essentially composed of elements which are disposed in the form of a trapezoid. Herein, the individual elements of the holding device can be preferably formed by tubes which are welded to each other. Herein, tubes having a circular cross section, tubes having a square cross section as well as combinations of the same ones can be used. Advantageously, at least the tubes of the rotation axis of the bearing element and the tubes of the rotation axis of the holding element comprise a circular cross section. The trapezoidal design of the stand frame assures on the one hand that the holding device has got a secure stand and facilitates on the other hand the ergonomics of the treatment of the surfaces of rim-like bodies. The background of this is that the treatment, in particular the painting, is carried out by means of a spraying device, for instance a spraying tool. The material to be applied is supplied to the spraying device, for instance the spraying tool, via a hose connected to the spraying device. The trapezoidal design of the stand frame assures that the hose cannot get caught in the stand frame and thus a painter who is treating the surfaces of rim-like bodies will not be interrupted in his working operation. Runs or color mists and dust inclusions related thereto can be furthermore avoided because no material can be applied in an unintended manner to places which are not provided for this.

One embodiment of the invention is characterized in that the stand frame, which is essentially composed of elements that are disposed in the form of a trapezoid, comprises a vertically oriented base side, preferably a tube which is spaced from the ground, wherein the base side comprises a receiver for the at least one bearing element. Herein, for example a free leg of the U-shaped bearing element can comprise a tube which is at the end thereof rotated by 90° with respect to the other free leg and which engages in the receiver of the base side of the stand frame. If tubes having a circular cross section are used for the bearing element, the base side of the stand frame of the holding device according to the invention advantageously also comprises a tube having a circular cross section. A secure hold of the U-shaped bearing element is for example assured by a locking mechanism. Herein, the locking mechanism is mounted on the base side of the stand frame and allows the fixation of a U-shaped bearing element. The U-shaped bearing element can accordingly be mounted or dismounted in a quick and simple manner with or without a rim mounted on the bearing element. One advantage of this is that rims which have to be treated differently can be quickly mounted or dismounted on the stand frame. In particular in comparison to the fixation of the rim to the holding element by means of for instance a screw it is possible to save time. Furthermore, the contact between a work piece and the surface of the rim to be treated can be avoided, which might for example happen when a screw by means of which a rim to be treated is fixed to the holding element is loosened.

If two locking mechanisms which are respectively disposed on the base side of the stand frame are used, two U-shaped bearing elements can be provided which can be rotated and dismounted or mounted independently from each other. The advantage of the independent rotatability, if two U-shaped bearing elements are disposed on the stand frame, is over all that spray mist on a rim which has not been painted so far but is already mounted on the device can be avoided. Furthermore, the stand frame according to the invention provides for a stable and secure stand such that at least one rim-like body can be treated almost without any obstacles by a painter. Damages to the rim which are caused by falling down can furthermore be prevented because of the secure stand of the device according to the invention.

Another embodiment of the invention provides that two inclined axes or sides, preferably tubes which are designed as legs of the stand frame are disposed on the base side of the stand frame composed of elements which are essentially disposed in the form of a trapezoid, which tubes preferably form an inner angle with the base side of about 100° through 130°. One could also imagine solutions in which only one leg or more than two legs are used as stand frame of a holding device according to the invention. It has however been found that in particular a trapezoidal design of the stand frame assures a high stability and offers ergonomic advantages with respect to the treatment of rim-like bodies.

Another embodiment of the invention is characterized in that floor stands, preferably tubes, are disposed on the inclined axes of the stand frame composed of elements which are essentially disposed in the form of a trapezoid, wherein the ends of the floor stands are preferably chamfered under an angle of about 15° to about 75°. The ends of the floor stands are in particular chamfered for avoiding injuries of the painter. Furthermore, the floor stands should have a sufficient length and be advantageously disposed orthogonally with respect to the orientation of the base side of the essentially trapezoidal stand frame. This contributes to a stable and secure stand of the holding device. The stable and secure stand is in particular important if loads—also several loads and/or loads having different weights—are placed on the stand frame. Herein, the different loads can for example consist of rim-like bodies having different sizes. At least one roller, preferably a roller that can be folded and/or folded away and/or connected, can be arranged on at least one floor stand, in order to be able to assure a slight mobility of the holding device. Another advantageous embodiment of the invention provides an advantageously detachable transport handle which can be fastened to one of the inclined axes or sides of the stand frame, preferably by means of a screw or a quick release fastener, catch means or a like fastening means which enables a quick mounting or dismounting of the transport handle.

In the solution according to the invention, all elements of the stand frame, in particular the base side, the inclined axes and the floor stands as well as the at least one bearing element, in particular the free legs and the connecting leg of the bearing element, can be telescope and/or catch means in order to allow a manifold adjustability of the holding device according to the invention. Thus, the holding device can be adapted to very different application cases, for example different working heights and/or different rim sizes.

Other details, characteristics and advantages of the invention will become apparent in the following by means of the exemplary embodiments represented in the figures of the drawing.

### BRIEF DESCRIPTION OF THE DRAWING

FIG. 1 is a schematic diagram of a holding device according to the invention in a slightly perspective front view;

FIG. 2 is a schematic diagram of a holding device according to the invention in a perspective diagonal view showing a rim fastened to a holding element of the holding device;

FIG. 3 is a schematic detailed diagram of a holding element of a holding device according to the invention in a front view;

FIG. 4 is a schematic diagram of another holding device according to the invention in a perspective diagonal view; and

FIG. 5 is a schematic diagram of the elements which form a bearing element and a holding element of the holding device according to FIG. 4.

### DETAILED DESCRIPTION

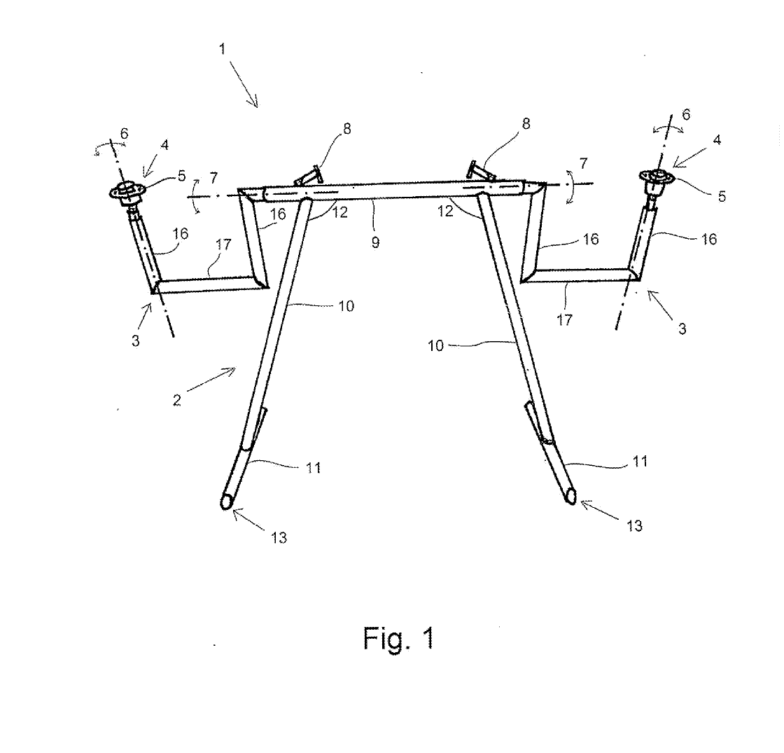

FIG. 1 shows a holding device for the surface treatment, in particular for painting two rim-like bodies, especially two rims, by means of a spraying device or a spraying tool. The holding device 1 comprises a trapezoidal stand frame 2 and two U-shaped bearing elements 3 which are mounted on the stand frame 2 in a rotatable or pivotable manner. On one of their free legs the two bearing elements 3 respectively comprise a holding element 4. The two holding elements 4 are each designed like a flange and are provided with offset bores 5 such that respectively one rim-like body, in particular a rim, can be fastened to the flange-like holding element 4 by means of at least one fastening means 15. The fastening means 15 can be for instance a wheel bolt. The holding element 4 can be rotated by 360° around a rotation axis 6. This is exemplarily shown by the double arrow near the rotation axis 6.

The two U-shaped bearing elements 3 of the holding device 1 respectively comprise two free legs 16, the lengths of which are designed such that it is possible to fasten rims that are available on the market and have common insets to the holding elements 4 of the holding device 1. Herein, the free legs 16 of the respective bearing element 3 extend essentially in parallel with respect to each other. The bearing element 3 furthermore comprises a connecting leg 17 which has an appropriate length for receiving rims that are available on the market and that comprise a predetermined radius or diameter. The connecting leg 17 of the bearing element 3 extends essentially perpendicularly to the two free legs 16 of the bearing element. The bearing element 3 can pivot about 360° around a rotation axis 7. This is exemplarily shown by the double arrow near the rotation axis 7. Herein, the rotation axis 7 is orthogonal to the rotation axis 6.

The bearing elements 3 can respectively be fixed by means of a locking mechanism 8 in order to fix the bearing elements 3 in different rotation angles around the rotation axis 7. Herein, the bearing elements 3 can be rotated and accordingly also mounted or dismounted independently from each other.

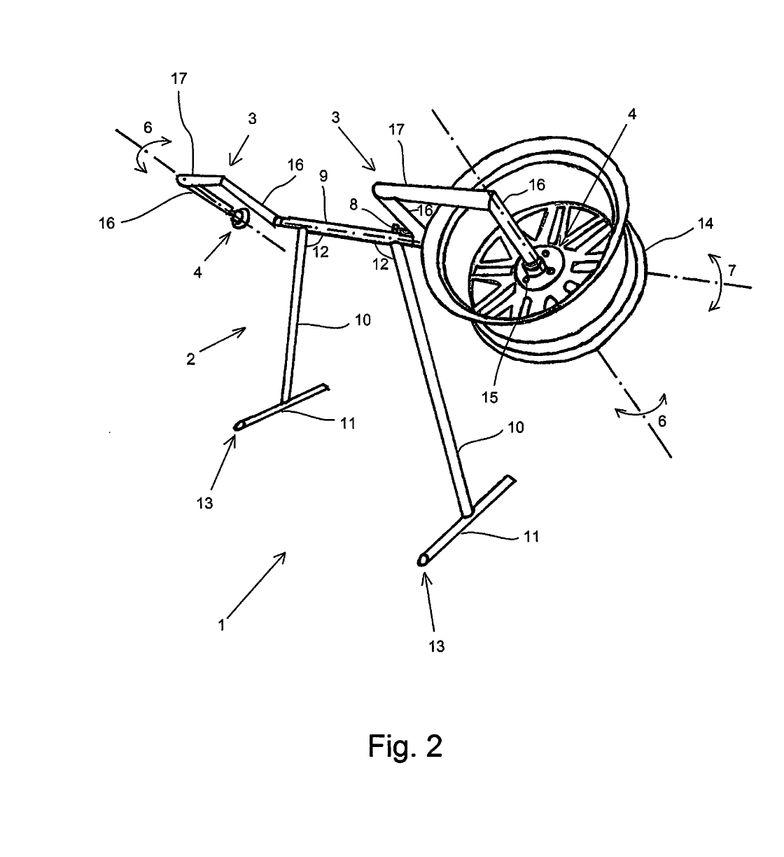

The use of two different rotation axes 6 and 7 enables to place for example a rim 14 from FIG. 2 in different positions on the holding device 1. This allows the painter to carry out the treatment of the surface of a rim 14 in one continuous working operation without having to change the position. A painter can furthermore treat a rim 14 in a continuous working operation since a rim 14 can be newly positioned by means of the holding device 1 according to the invention without having to remove the rim 14 from the receiver in an additional working step, such as known from the state of the art, and to mount it again on the receiver in a changed position.

The holding device 1 comprises a stand frame 2. The stand frame 2 comprises a base side 9 and is a tube that is about 120 cm spaced from the ground. Two inclined axes or sides 10 are welded to the base side 9 of the stand frame 2, which axes serve as legs of the stand frame 2. One floor stand 11 is respectively disposed on each inclined axis or side 10, which floor stand 11 is formed by a tube which extends orthogonally to the base side 9 and an imaginary axis or side which extends vertically to the base side 9. The stand frame 2 is a trapezoid formed by the base side 9 and the two inclined axes or sides 10. The two inclined axes 10 are arranged with respect to the base side 9 such that they form an inner angle α(referenced by the reference numeral 12) of about 110° with it. The base side 9 is designed to receive two U-shaped bearing elements 3. On the free leg 16 which is allocated to the stand frame 2, each of the two U-shaped bearing elements 3 comprises a tube which is rotated or offset by 90° with respect to the free leg 16. This tube reaches through the receiver on the base side 9, i.e. the tube of the base side 9 of the stand frame 2 or it engages in this tube of the base side 9 of the stand frame 2 and thus forms the bearing of the rotation axis 7.

The two floor stands 11 are designed as two steel tubes which have the same diameter and are welded horizontally and the ends of which are chamfered for avoiding injuries. This chamfer 13 of the floor stands 11 is referenced by the reference numeral 13 in FIG. 1. The trapezoidal construction of the stand frame 2 assures that both only one and two rims 14 having the same or different dimensions can be held and treated by the holding device which is standing in a stable manner. Due to the use of tubes as material of the individual elements, the stand frame 2 is sufficiently light for being moved by one person. The floor stands 13 can furthermore be provided with rollers in order to obtain a still better mobility of the holding device 1.

In FIG. 2 a holding device 1 according to the invention is represented with a rim 14 fastened to a holding element 4 which is placed on the right side with respect to the observer. A fastening means 15, in particular a wheel bolt is used in order to fasten the rim 14 to the holding element 4. As it is furthermore visible in FIG. 2, the U-shaped bearing elements 3 are represented as being turned or pivoted around the rotation axis 7 of the holding device with respect to the orientation of the bearing elements 3 that is represented in FIG. 1. In contrast to the exemplary embodiment in FIG. 1, the present holding device 1 according to the exemplary embodiment according to FIG. 2 only comprises one locking mechanism 8 which simultaneously fixes both bearing elements 3. The two bearing elements 3 comprise a common rotation axis 7 such that the turning of a bearing element 3 entails or causes the turning of the other bearing element 3. It is furthermore visible that the free legs 16 of the U-shaped bearing element 3 have a suitable length for receiving the rim 14 having a given inset. Furthermore, the connecting leg 17 of the U-shaped bearing element comprises such a length that it is able to receive the rim having a given radius or diameter. In spite of the fact that in the represented exemplary embodiment a rim 14 is only fastened to one of the two holding elements 4, the holding device 1 has a stable and secure stand, in particular due to the trapezoid design of the stand frame 2 and the geometry of the bearing elements 3 respectively holding elements 4 adapted to this design.

Thanks to the construction of the holding device 1, the rim 14 is accessible from all sides without having to remove it or to change the position of the working painter and independent from the inset and the width of the rim 14. Thus it is easier to paint the rim 14. Exact results can be obtained and any so called paint runs and over-spraying during the application of paint as well as color mists and dust inclusions related thereto can be avoided to a large extend. This saves both paint and working time and significantly improves the ergonomics of the painting operation. This is of special importance when special paint works, such as for instance multicolor painting or painting with decorative strips are concerned, since the rim 14 can be for example masked and painted with different colors and/or materials in a continuous working operation. Preparatory and subsequent works required for the treatment of the surface of the rim 14, such as for example filling, grinding and/or polishing of the rim 14, can also be carried out during the same working operation without dismounting the rim 14. Thanks to the use of two rotation axes 6 and 7 and a given balance of the rim 14 which is obtained in that the rim 14 to be treated can be essentially fastened with its center of gravity in the intersection point of the two rotation axes 6 and 7 and thanks to the trapezoid stand frame 2, it is possible to achieve an excellent workability, especially also of large rims. Furthermore, an improved air circulation on the surface of the rim 14 to be treated can be obtained due to the biaxial rotatability of the holding device 1. In the represented embodiment of the holding device 1 it is possible to treat two rims 14 at the same time. Herein, a first rim 14 can remain in a position, in order to treat it further afterwards, while a similar, identical or different working operation is carried out on the second rim 14.

Furthermore it is visible that the flange of the holding element 4 has got a diameter which is approximately congruent with the contact surface of the rim 14 which rests upon a wheel hub of a wheel suspension of a car.

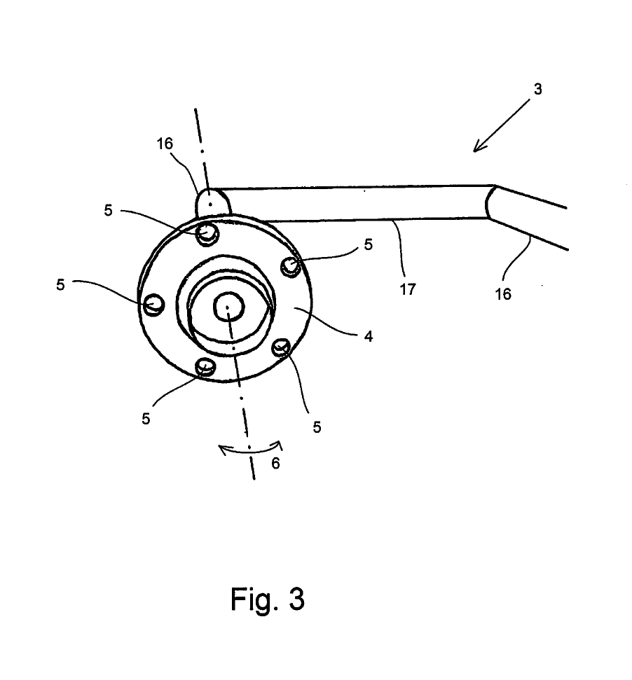

FIG. 3 is a schematic diagram which shows a holding element 4 of a holding device 1 according to the invention, which holding element comprises a flange. The holding element 4 comprises five bores 5 into which fastening means, especially wheel bolts 15 or the like, can engage in order to assure a stable and secure hold with respect to the fastening of a rim 14. The symmetrical arrangement of the bores 5 on the holding device 4 enables to fasten rims 14 having different bolt circles to the holding element 4. The holding element 4 comprises a bearing such that the holding element 4 can be rotated or pivoted by 360° around a rotation axis 6. This is exemplarily represented by the double arrow which is placed on the rotation axis 6.

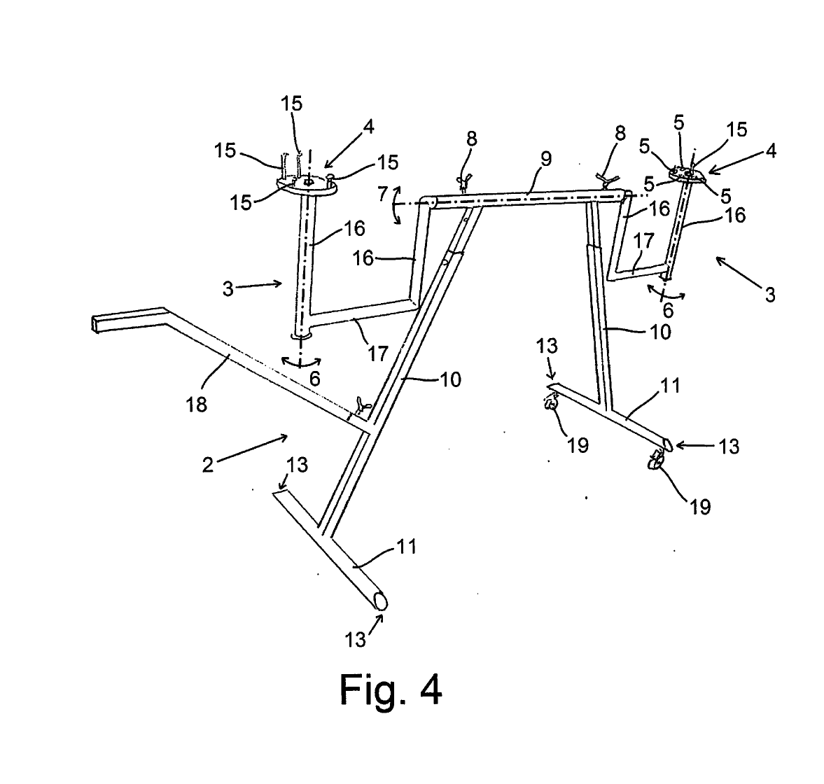

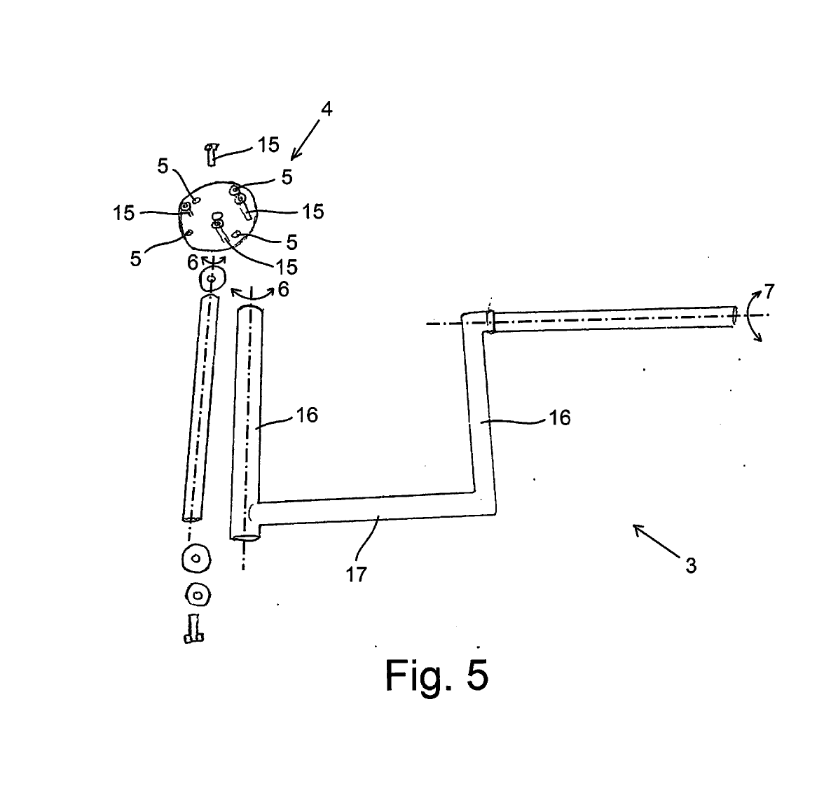

FIG. 4 and FIG. 5 show another exemplary embodiment of a holding device 1 for at least one rim-like body for the surface treatment of the at least one rim-like body, in particular for painting the rim-like body by means of a spraying device or spraying tool. The holding device 1 also comprises a stand frame 2 formed by elements that are arranged in a trapezoidal manner, in particular tubes having a circular cross section and tubes having a square cross section, the stand frame 2 comprising two essentially U-shaped bearing elements 3 which are mounted on the stand frame 2 such that they can be respectively rotated or pivoted around a rotation axis 7 of the stand frame 2. Herein, the bearing elements 3 can be respectively locked on or with respect to the rotation axis 7 preferably in a stepless manner by means of a locking mechanism 8. Herein, the locking 8 is advantageously realized by means of screws 8 which engage in the tube of the base side 9 of the stand frame 2 perpendicularly to the rotation axis 7, for which purpose the tube of the base side 9 of the stand frame 2 preferably comprises a threaded bore. Like the bearing elements 3 of the holding devices 1 according to FIG. 1 through FIG. 3, the U-shaped bearing elements 3 comprise two free legs 16 which extend essentially in parallel with respect to each other and a connecting leg 17 which extends perpendicularly to these ones. One holding element 4 is respectively arranged on one of the free legs 16 of the bearing elements 3, which holding element 4 is disposed on the respective bearing element 3 such that it can be rotated or pivoted around a rotation axis 6. The at least one rim-like body can be fastened to the holding element 4 by means of wheel bolts or cone bolts or like fastening means 15. The rotation axis 6 is essentially perpendicular to the rotation axis 7.

In the present case, the bearing elements 3 and the base side 9, which is spaced from the ground, of the stand frame 2 of the holding device 1 are formed by tubes having a circular cross section. Apart from the flange and the fastening means of the respective holding element 4, the same is true for the holding element 4 (cf. FIG. 5). In the holding device 1 represented in FIG. 4 and FIG. 5, the inclined sides 10 of the stand frame 2 are formed by tubes having a square cross section, which tubes in particular further improve the stand and the stability of the holding device 1 and can be worked and welded more easily. Herein, the inclined sides 10 of the stand frame 2 are advantageously formed by telescoping tubes which are pluggable into each other and are welded to the tube of the base side 9 of the stand frame 2, which tube forms or provides the rotation axis 7. Thanks to the telescopic capability of the inclined sides 10 of the stand frame 2, the height of the base side 9 of the stand frame can be adjusted. The inclined sides 10 of the stand frame can be furthermore selected with a different length, in particular for height adaptation, if for example rollers 19 are used. As in the exemplary embodiments according to FIG. 1 through FIG. 3, floor stands 11 made of tubes are provided at the ends of the respectively other tube of the inclined sides 10 of the stand frame 2. In the present case, the tubes of the floor stands have a circular cross section and are provided with a chamfer 13 at their ends. The inclined side 10 of the stand frame 2 of the holding device 1, which inclined side is represented on the left side in FIG. 4, is provided with a transport handle 18 which is composed of tubes having a square cross section and which extends under an angle essentially in parallel to the base side 9 of the stand frame 2. The transport handle 18 can be detachably fastened to the inclined side 10 of the stand frame 2 of the holding device 1, which inclined side 10 is represented on the left side in FIG. 4, by means of a screw or like fastening means. The floor stand 11 of the inclined side 10 of the stand frame 2 of the holding device 1, which inclined side 10 is represented on the right side in FIG. 4, is in the present case provided with rollers 19 at its free ends, preferably with lockable rollers 19 and can thus be manually displaced if the holding device 1 is lifted up by means of the transport handle 18. Herein, the rollers 19 are mounted on the floor stand 11 such that these ones do not extend beyond the chamfer 13, in order to avoid that a hose gets caught or the painter stumbles over the rollers.

The entire treatment process of a rim-like body can comprise the following working steps:
fastening the rim-like body 14 to a holding element 4 by means of at least one fastening means 15;
carrying out possibly required preparatory works, such as for example cleaning and grinding the surface of the rim-like body 14;
treating the surface of the rim-like body 14, in particular painting the surface of the rim-like body 14 by means of a spraying device or a spraying tool;
carrying out a possibly required drying of the treated surface of the rim-like body;
carrying out possibly required reworks, for example removing unintended material applications at the bores of the wheel bolts on the rim-like body 14 by quickly and easily removing any paint residues at this spot, which is relevant for the hold of the rim-like body 14 on the axis of a vehicle, with a single movement of the hand by means of a drill attachment in form of a cylindrical wire brush which is adapted to the dimension of the standard bore; and dismounting the finished rim-like body 14 from the holding device 1 according to the invention.

The exemplary embodiments represented in the figures of the drawing only serve for explaining the invention and are not limiting to this one.

### LIST OF THE REFERENCE NUMERALS

1 holding device
2 stand frame
3 bearing element
4 holding element/flange
5 bore
6 rotation axis (holding element)
7 rotation axis (bearing element)
8 locking mechanism
9 base side
10 inclined axis
11 floor stand
12 inner angle α
13 chamfer
14 rim
15 fastening means/wheel bolt/cone bolt
16 free leg
17 connecting leg
18 transport handle
19 roller

What is claimed is:

1. A holding device for at least one rim-like body for the surface treatment of the at least one rim-like body, in particular for painting it by means of a spraying device, the holding device comprising:
a stand frame;
at least one bearing element which is mounted on the stand frame such that it can be rotated or pivoted around a rotation axis; and
at least one holding element which is mounted on the bearing element such that it can be rotated or pivoted around a rotation axis and to which the at least one rim-like body can be fastened.

2. The holding device according to claim 1, wherein the direction of the rotation axis of the bearing element is different from the direction of the rotation axis of the holding element.

3. The holding device according to claim 1, wherein the rotation axis of the bearing element is orthogonal to the rotation axis of the holding element.

4. The holding device according to claim 1, wherein the at least one bearing element can be locked on the stand frame.

5. The holding device according to claim 1, wherein the at least one bearing element is essentially U-shaped, wherein the U-shape comprises two free legs and a connecting leg.

6. The holding device according to claim 5, wherein the lengths of the legs of the at least one essentially U-shaped bearing element are adapted and/or can be adapted to the size of the at least one rim-like body.

7. The holding device according to claim 5, wherein the free legs of the at least one essentially U-shaped bearing element comprise a length of approximately 20 cm to approximately 80 cm, preferably approximately 35 cm to approximately 65 cm, most preferably approximately 45 cm to approximately 55 cm.

8. The holding device according to claim 5, wherein the connecting leg of the at least one essentially U-shaped bearing element comprises a length of approximately 20 cm to approximately 70 cm, preferably approximately 30 cm to approximately 60 cm, most preferably approximately 40 cm to approximately 50 cm.

9. The holding device according to claim 1, wherein the at least one holding element can be locked on the at least one bearing element.

10. The holding device according to claim 1, wherein the at least one holding element is designed like a flange and the at least one rim-like body can be fastened by means of at least one fastening means to the flange-like holding element, preferably to the free leg of the essentially U-shaped bearing element on which the at least one flange-like holding element is mounted in a rotatable or pivotable manner.

11. The holding device according to claim 10, wherein the diameter of the flange-like holding element is comprised between approximately 5 cm and approximately 20 cm, preferably between approximately 7 cm and approximately 17 cm, most preferably between approximately 11 cm and approximately 14 cm.

12. The holding device according to one claim 1, wherein in that the stand frame is essentially composed of elements which are disposed in the form of a trapezoid, preferably tubes having circular cross sections and/or tubes having square cross sections.

13. The holding device according to claim 12, wherein the stand frame, which is essentially composed of elements that are disposed in the form of a trapezoid, comprises a vertically oriented base side, preferably a tube which is spaced from the ground, wherein the base side comprises a receiver for the at least one bearing element.

14. The holding device according to claim 13, wherein two inclined axes, preferably tubes which are designed as legs of the stand frame, are disposed on the base side of the stand frame composed of elements which are essentially disposed in the form of a trapezoid, which tubes preferably form an inner angle with the base side of about 100° through 130°.

15. The holding device according to claim 14, wherein floor stands, preferably tubes, are disposed on the inclined axes of the stand frame composed of elements which are essentially disposed in the form of a trapezoid, wherein the ends of the floor stands are preferably chamfered under an angle of about 15° to about 75°.
